(19) United States
(12) Patent Application Publication
(10) Pub. No.: US 2024/0088771 A1
(43) Pub. Date: Mar. 14, 2024

(54) IMPROVEMENT TO POWER GENERATION BY MOTION TRANSFORMATION

(71) Applicant: Federico Marquez Lopez, Chihuahua (MX)

(72) Inventor: Federico Marquez Lopez, Chihuahua (MX)

(21) Appl. No.: 18/263,544

(22) PCT Filed: Feb. 14, 2022
(86) PCT No.: PCT/US2022/016302

§ 371 Date: Jul. 31, 2023

Related U.S. Application Data
(60) Provisional application No. 63/149,651, filed on Feb. 15, 2021.

(51) Int. Cl. H02K 35/02

(52) U.S. Cl. CPC H02K 35/02

(57) ABSTRACT

A power generation method and system have been provided. The method includes pre-loading a generator or alternator coil with a voltage to increase a power output. The method further includes counteracting or balancing forces of attraction of reciprocating moving magnet to an iron core coil with forces of a rotor magnet in a power generation by motion transformation. The method further includes counteracting or balancing forces of the attraction of the reciprocating moving magnet to the iron core coil with other forces of reciprocating moving magnet(s) to the iron core coil in the same linear alternator or generator to control alternator cogging forces.

### CROSS-REFERENCE TO RELATED APPLICATIONS

This application is a national stage entry of PCT/us2022/016302 filed Feb. 14, 2022, under the International Convention and claiming priority over U.S. Provisional Patent Application No. 63/149,651, filed on Feb. 15, 2021, the contents of which are incorporated herein by reference in their entirety.

### FIELD OF THE INVENTION

The present invention disclosed herein generally relates to electric power generation. More particularly, the present invention discloses electric power generation, and it intends to extract the mechanical movement power generated in the reciprocating movement described in PCT; IB2018/060628 Power Generation—Using Motion Transformation, which improvement was found to be useful for other power generators. The present invention further discloses configuration of the power generation system to better take advantage of the produced movement into electric power and reduce material use like copper in generators.

### BACKGROUND OF THE INVENTION

The current products offered by the power generation industry are deficient in meeting customer needs. For example, current generator sets are limited to single voltages at a designed output frequency, that is, the generator sets operate at fixed revolutions per minute (rpms) which is limiting the usefulness of current power generation systems. To handle the needs of customers that operate in a global environment, generator sets are either reconfigured after purchase, or multiple portable generator sets are purchased that operate with different respective frequencies and voltages power generation systems are needed to resolve these issues and more readily meet the needs of customers.

Power generator during power generation is accomplished by cutting the coil magnetic field lines. Most of the power is wasted to overcome the resistance to this reverse magnetic field generation, lowering the efficiency of power generation, and thus the generation of energy does not match the target. The first known electric power generation was Faraday's copper loop induced by a magnet moving through it. In the traditional mechanism, once the movement is done approximating the magnet into the iron core of the coil, there will be resistance to separate them due the attraction of the magnet to the iron. The needed force is not really wasted as the attracting force will help in the way back, but increases the top force needed. In rotary generators, this is perceived as cogging. In POT/IE320181060628 Power Generation—Using Motion Transformation, the cogging force are used to produce power by the motion transformation of them, in one way the reciprocating movement requires more force, but in the other direction it has force in favor, there it is used to generate power, helped by the cogging, and here are used for it to retain movement until peak force of the rotor is shown.

Also, previously disclosed PCT/IB2018/060628 Power Generation—Using Motion Transformation, describes a generator of electric power and this improvement to it makes in combination a better configuration for a power generation in better electric conditions and obtaining advantages over the first disclosed product. Therefore, the purpose of the present invention is to provide a configuration of the power generation system to better take advantage of the produced movement in the motion transformation. It will be understood that this disclosure is not limited to the systems, and methodologies described, as there can be multiple possible embodiments of the present disclosure which are not expressly illustrated in the present disclosure. It is also to be understood that the terminology used in the description is for the purpose of describing the versions or embodiments only, and is not intended to limit the scope of the present disclosure.

### SUMMARY OF THE INVENTION

It will be understood that this disclosure is not limited to the system described herein, as there can be multiple possible embodiments of the present disclosure which are not expressly illustrated in the present disclosure. It is also to be understood that the terminology used in the description is for the purpose of describing the versions or embodiments only and is not intended to limit the scope of the present disclosure.

It is an objective of the present invention to provide a better configuration for electric power generators, and it intends to extract the mechanical movement described in POT/IB2018/060628 “Power Generation—Using Motion Transformation in electric power in the best possible conditions. The present invention further discloses configuration of the power generation system to better take advantage of the produced movement in the motion transformation.

It is an objective of the present invention to provide electric power generation method for motion transformation generators. The method includes pre-loading a generator or alternator coil with a voltage to increase a power output. The mechanism further includes counteracting or balancing forces of attraction of reciprocating moving magnet into an iron core coil with forces of a rotor magnet of PCT/IB2018/060628 Power Generation—Using Motion Transformation. The mechanism further includes counteracting or balancing forces of the attraction of the reciprocating moving magnet to the iron core coil with other forces of reciprocating moving magnet(s) to the iron core coil in the same linear alternator or generator to control alternator cogging forces.

These and other features and advantages of the present invention will become apparent from the detailed description below, in light of the accompanying drawings.

### BRIEF DESCRIPTION OF THE DRAWINGS

The foregoing summary, as well as the following detailed description of the innovation, is better understood when read in conjunction with the appended drawings. For the purpose of illustrating the innovation, exemplary constructions of the innovation are shown in the drawings. However, the innovation is not limited to the specific methods and structures disclosed herein. The description of a method step or a structure referenced by a numeral in a drawing is applicable to the description of that method step or structure shown by that same numeral in any subsequent drawing herein.

FIG. 1 is a diagram that illustrates an effect of acceleration from zero velocity for PCT/IB2018/060628 Power Generation-Using Motion Transformation, according to an exemplary embodiment.

FIG. 2 is a diagram that illustrates a series of conditions to make a configuration for PCT/IB2018/060628 Power Generation—Using Motion Transformation, according to an exemplary embodiment.

FIG. 3 is a diagram that show behavior of different wave forms of voltage in power generation, generator without this configuration and using this configuration and sine wave form traditional to other generators and the same generator voltage wave form using this configuration.

FIG. 4 is a diagram expressing how magnetic forces of permanent magnet interact into an iron core coil, and is counteracted by other permanent magnet force.

Further areas of applicability of the present invention will become apparent from the detailed description provided hereinafter. It should be further understood that the detailed description of exemplary embodiments is intended for illustration purposes only and is, therefore, not intended to necessarily limit the scope of the invention.

### DETAILED DESCRIPTION OF THE INVENTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which contribute to improvement of power generation by motion transformation. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

References to “one embodiment”, “an embodiment”, “another embodiment”, “yet another embodiment”, “one Example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items.

Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed apparatuses have been described below, it should be understood that they have been presented for purposes of example only, and not limitations. It is not exhaustive and does not limit the present invention to the precise form disclosed. Modifications and variations are possible in light of the below teachings or may be acquired from practicing of the present invention, without departing from the breadth or scope.

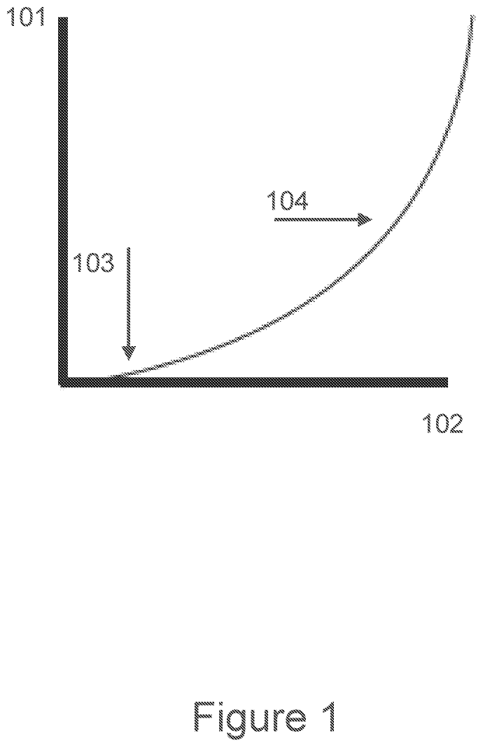

The innovation to power generation by motion transformation of the present invention will now be described with reference to the accompanying drawings, which should be regarded as merely illustrative without restricting the scope and ambit of the present invention. Embodiments of the present invention will now be described with reference to FIGS. 1-4 to present a detailed overview of the power generation.

The present invention refers to methods to extract energy or power in electric form from a generator or alternator and is related to POT patent application WO2019130224—POWER GENERATION USING MOTION TRANSFORMATION. While the mechanical function is described in the previous patent and a linear generator is described in it, the reciprocating movement of it, makes a full stop-and-then-back in other direction, stop-and-go, and the short stroke distance to make it efficient, by maintain of similar magnetic force of rotor to reciprocating movement magnet, and this is obtained only in short distance as distance reduce magnetic force, that makes the mechanical movement by magnetic forces efficient. This makes the velocity to be slow even under high acceleration, force, and power. The voltage generation exciting a copper coil by magnet movement is given the influence of the magnetic force strength, the length of the wire in the copper coil, and the velocity of magnet relative to the coil, formula is known as EMF=B1V, Where EMF means Electro Magnetic Force, B is the Magnetic Field, 1 is length of the wire, and V is Velocity of magnet. Obtaining a high voltage enough to extract the mechanical power (WO2019130224—POWER GENERATION USING MOTION TRANSFORMATION) becomes hard due the slow velocity reasons described, also obtaining a high voltage enough to extract the mechanical power transformed into electric power in a reduced space given the nature of the generator, where increasing copper length may not fit. It becomes so hard to obtain an electric high power given a low voltage, given that Power=Voltage×Current, current would need to be very high to produce more power, to increase current wire was needed to have more width to increase capacity of the flow, and space also limits it, also increasing turns produces a higher induction which can produce reluctance given the relation to resistance, making it hard to extract the energy in electric way. So, the present invention has been developed as a result to solve it. One of them refers to mechanical improvement for the polarity change exposed from the rotor to the reciprocating movement magnet, making an effect to be more efficient as the first experiments expressed that the reciprocating movement in WO2019130224-POWER GENERATION USING MOTION TRANSFORMATION started as soon as the polarity of rotor magnet is changed and it changes gradually so the movement was made in the lower force of power movement, while the actual innovation allow it to be made at peak force of the magnets force between the rotor magnet to the reciprocating movement magnet in WO2019130224—POWER GENERATION USING MOTION TRANSFORMATION, making more power, and also more velocity to increase voltage produced. Other part of this patent makes an electronic definition to increase the voltage of the generator by inducing a voltage into the coil previous to the induction or excitement of the coil by the magnet, so the voltage of the generator is the added value of the pre charged coil voltage plus the generation voltage produced by the magnetic field force, velocity of movement and length of the coil, this creates a higher voltage, and induced pre charge can be very high and this makes the generator maximum electric power output higher, if the force of the mechanical movement in WO2019130224—POWER GENERATION USING MOTION TRANSFORMATION is enough to make the higher power move, so given Power=Voltage×Current, now having a higher Voltage, even the same Current capacity of the coil will have a higher power capacity, if the movement is enough to move it. This was seen in linear electric generators that responded in current change to the voltage change given the velocity change when the power in movement did remain, so higher power is possible under this configuration.

Adding pre charge voltage require the need to coordinate the magnet movement with the voltage pre charge as coil changes current direction as result of magnet direction change, and it allows to have higher voltage generator, the power of mechanical movement has to be consider as, the formula states Power=voltage×current, so the increase of voltage may result in the need of higher power, in this case force in the reciprocating magnet movement will need power according to move the new capacity as this do not created more energy, just allows more transformation of mechanical into electrical power, and produce more power even if the linear generator is the same and can produce the same amount of current given resistance or wire capability, the increased voltage may increase the total power output capability, which will result in more mechanical force or power form the reciprocating magnet, this innovation may never extract more electrical power than the mechanical movement and is not intended, but it may allow to extract the mechanical power in easier way into electric power.

FIG. 1 is a diagram that illustrates an effect of acceleration from zero velocity, according to an exemplary embodiment of the present invention. FIG. 1 shows the effect of acceleration from the zero velocity. The graph (shown in FIG. 1) has velocity in Y-axis and distance in X-axis. The acceleration makes an exponential effect in the velocity 104 but a short movement only reaches a fraction of the velocity 103. Given the relation of power generation by an inductor, the voltage is in direct relation to the velocity of the magnet moving through the wire loop, limiting the voltage produced, and even if the power is great the in the movement, the electric output is low as is the result of voltage times amperage (current).

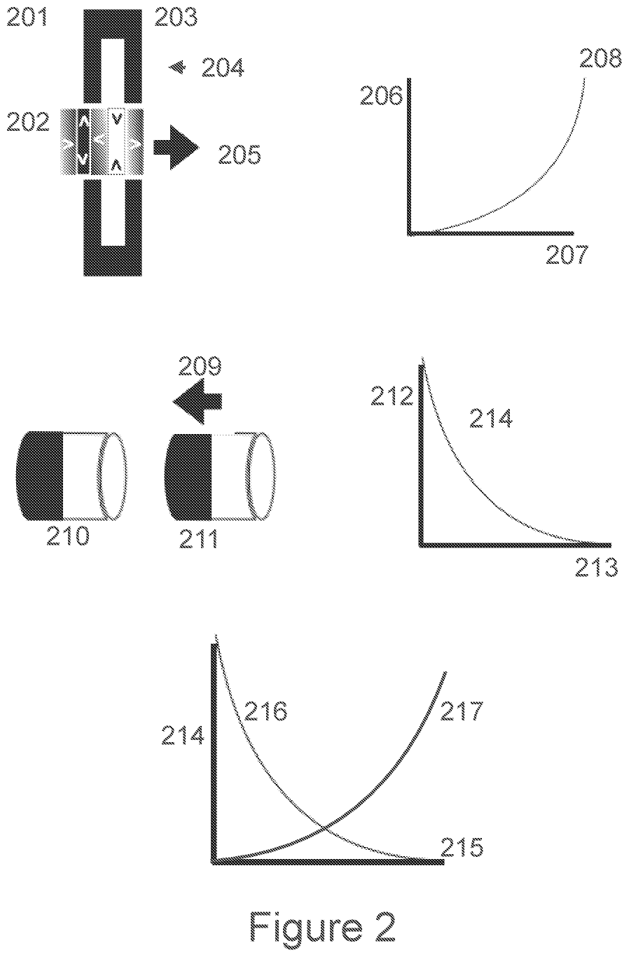

FIG. 2 is a diagram that illustrates a series of conditions to make the power generation using motion transformation (POT application POT/IB20181060628—POWER GENERATION USING MOTION TRANSFORMATION), according to an exemplary embodiment of the present invention. FIG. 2 shows the conditions to make the configuration for the power generation to mechanically increase the velocity of the reciprocating movement to increase the voltage and the use of ferrous core to increase the magnetic field change to increase the voltage, and also start the movement at the peak magnet force, instead of the lower magnetic force needed to move the reciprocating movement in the POT application “PCT/IB2018/060628—POWER GENERATION USING MOTION TRANSFORMATION” while the ferrous core has attraction to the induction magnet 202 thereby producing a force 205 towards the ferrous material 203 in the coil 201. The force 205 of attraction of the induction magnet 202 increases with proximity to the ferrous core as shown exponential 208 increase on the graph and can also be linear depending on the design of the generator. If we see the force of attraction 209 or rejection of two magnets 210 and 211, it has a similar behavior where force 212 is decreased as the magnets separate in distance 213 making an exponential decreasing force 214. Using this two-relation counter acting the forces makes a movement graphic 214 where one force decrease 216 while the other increase 217 making a movement hard to start but accelerates to the other side. So the attraction of the induction magnet to the ferrous coil do not allow the reciprocating movement until the rotor magnet of the POT application “PCT/IB2018/060628—POWER GENERATION USING MOTION TRANSFORMATION” reaches a force higher than that, making the movement at peak forces not minimum force to be move as we experimented, the force of magnets is better this way in mechanical way, this is to make a violent movement that makes more velocity because mechanism in the power generator by motion transformation started not when polarity had just changed and started the movement at the lowest power change, but at peak force to overpass the attraction of induction magnet to ferrous coil. Here, the high starting forces 217 and 216 make the movement more violent and starts when the rotation magnet reaches that force and not before. This makes movement with more velocity and at better force point of rotating magnet of the power generation by motion transformation.

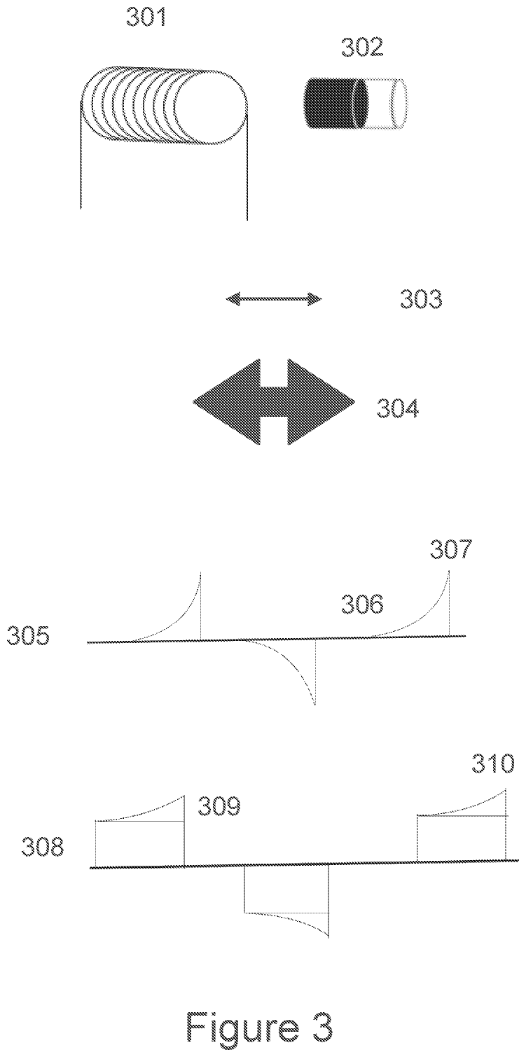

FIG. 3 is a diagram that illustrates the electric power generation by an induction coil 301. excited by a magnet 302, according to an exemplary embodiment of the present invention. The electric power generation by the induction coil 301 is excited by the magnet 301 that has a power output relative to its voltage and amperage (current) output that result in power output measured in watts which is the multiplication of both, in the short movement 303 of power generation by motion transformation. It is a short movement reducing the possible velocity and therefore the voltage produced is also low, if a voltage is induced in a little amperage quality the voltage will rise and therefore it makes possible a higher power output. Here is shown different wave forms, 305 is the wave form of voltage experimented in the POT application “PCT/IB2018/060628—POWER GENERATION USING MOTION TRANSFORMATION” that is in exponential increase given the relation to acceleration of the movement, reflected in the voltage generation. The other wave form 311 is a square waveform of an induced voltage pre charge with a very low amperage charge so it do not consumes much power and do not overpass the force created in the coil given the electromagnetic force produced. The force needed to move the magnet into the coil may rise in relation to the amperage produced, but this allows a higher power output from a given mechanical force and a more stable wave can be composed of a high voltage with very low current charge injected to the coil 308 plus the coil induce voltage by the magnet moving through it 309 making a total voltage output 310. This reduces the amount of induction needed and materials needed and increasing the power generator power density to volume and weight. The movement will not produce more power than the force of the mechanical movement that produces it but will allow higher voltages and lower copper use in the machine. This resulted to be useful to other generators, for example simple sine wave form 312 coming from normal generation in one phase, may also be possible to be pre charged to be lifted voltage and power adding the voltage of the square 311 pre charged induced voltage and 312 sine waves into a very particular wave form 313, may be useful to increase voltage and power capacity of the generator.

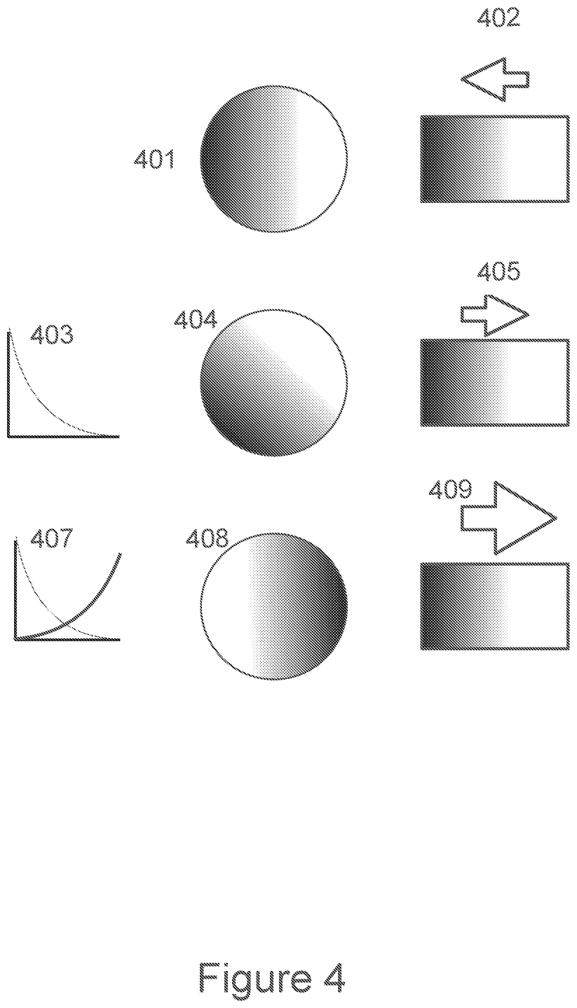

FIG. 4 is a diagram that elaborates the mechanism described in FIG. 2, according to an exemplary embodiment of the present invention. FIG. 4 illustrates why the mechanism described in FIG. 2 when the rotating magnet if power generator by motion transformation is made to produce electricity in linear generation without cogging the reciprocation or linear movement will start as soon as there is a slight magnet polarity change For example, from an attraction position of the rotor 401 to the reciprocating movement magnet 402 into the rejecting position of the rotor 405 into the reciprocation, the magnet will start the movement as soon as the lowest force needed to move it apprise as showing a graphic of no cogging force 403. While if the cogging force is induced to resist the position change by counter acting two magnetic forces, the induction magnet force described in FIG. 2, to the ferrous coil described in FIG. 2, will resist the reciprocating movement, until the rotor 408 exhibits enough force 409 to overcome the induction magnet force to ferrous coil, rising the initial starting force result of both forces counter acting and having an effect similar to the graph 407. Then the rotation magnet 408 will need to show the strongest area and the greatest force to counter act the cogging force and the resulting force and movement 409 will be stronger and faster.

In the present embodiment, electric power generation mechanism for motion transformation generator(s) has been disclosed herein. The mechanism includes pre-loading the generator or alternator coil with the voltage to increase the power output. The mechanism further includes counteracting or balancing forces of attraction of reciprocating moving magnet into an iron core coil with forces of a rotor magnet. The mechanism further includes counteracting or balancing forces of the attraction of the reciprocating moving magnet to the iron core coil with other forces of reciprocating moving magnet(s) to the iron core coil in the same linear alternator or generator to control alternator cogging forces.

The mechanism further includes counteracting or balancing forces of the attraction of the reciprocating moving magnet to the iron core coil with other forces of reciprocating moving magnet(s) to the iron core coil in the same linear alternator or generator to control alternator togging forces to have the force strength of a rotor in the power generation by motion transformation controlled to make movement time and force control for force, velocity, or time movement. The mechanism further includes synchronization of a pre-loaded voltage to the movement of the generator to coordinate with precision the voltage of pre charge and the generator EMF voltage by excitement of the coil.

In the present solution, instead of making the generator to start from zero voltage, a high voltage, from 20 volts to 400 volts, is inputted. Since the coil alone can produce only 0.4 volt and the wire allows only 0.4 amps, the power output is 1.6 watts (P=V*I). the mechanical move is around 750 watts. But with pre-loading 20 volts, the same coil or generator of 4 amps can now produce 80 watts. Thus, with pre-loading, the same generator makes 80 watts instead of 1.6 watts, which is a significant improvement to the existing solution.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

1. A method for power generation comprising the steps of:
pre-loading a generator or alternator coil with a voltage to increase a power output;
counteracting or balancing forces of attraction of a reciprocating moving magnet to an iron core coil with forces of a rotor magnet in power generation by motion transformation; and
counteracting or balancing forces of the attraction of the reciprocating moving magnet to the iron core coil with other forces of reciprocating moving magnet(s) to the iron core coil in a same linear alternator or generator to control alternator cogging forces.

2. The method of claim 1, further comprising the step of counteracting or balancing forces of the attraction of the reciprocating moving magnet to the iron core coil with the other forces of reciprocating moving magnet(s) to the iron core coil in a same linear alternator or generator to control alternator cogging forces to have the force strength of a rotor in the power generation by motion transformation controlled to make movement time and force control for force, velocity, or time movement.

3. The method of claim 1, wherein a force of attraction of an induction magnet increases with proximity to a ferrous core as an exponential increase and also are linear depending on the design of the generator.

4. The method of claim 1, wherein the forces needed to move the magnet into the coil rise in relation to an amperage produced, which allows a higher power output from a given force and a more stable wave are composed of a higher voltage of small current charge injected to the coil.

5. The method of claim 1, further comprising the step of synchronizing of a pre-loaded voltage to the movement of the generator to coordinate with precision the voltage of pre charge and the generator EMF voltage by excitement of the coil.

6. A power generation mechanism comprising:
a generator or alternator coil pre-loaded with a voltage to increase a power output.

7. The power generation mechanism of claim 6, the voltage is synchronized with a wave form of the generator.
